(19) United States
(12) Patent Application Publication
(10) Pub. No.: US 2011/0218307 A1
(43) Pub. Date: Sep. 8, 2011

(54) Systems and Methods for Fabricating Polymers

(75) Inventors: Mark G. Goode, Hurricane, WV (US); Kevin J. Cann, Rocky Hill, NJ (US); Ronald S. Eisinger, Charleston, WV (US); Barbara J. Kopp, Kinnelon, NJ (US); John H. Moorhouse, Kendall Park, NJ (US)

(73) Assignee: UNIVATION TECHNOLOGIES, LLC, Houston, TX (US)

(21) Appl. No.: 13/127,937

(22) PCT Filed: Dec. 11, 2009
(86) PCT No.: PCT/US2009/067605

§ 371 Date: May 5, 2011

(51) Int. Cl. C08F 4/69; G05D 7/00

(52) U.S. Cl. 526/113; 526/159; 526/126; 422/111

(57) ABSTRACT

The present invention is broadly directed to various methods and systems for gas and liquid phase polymer production. In certain embodiments, the methods are performed in conjunction with a polymerization reactor system such as gas phase reactor system or liquid phase reactor system. The invention is also broadly directed to various systems in which polymer properties are manipulated by addition of DEALE directly to a polymerization reactor system.

### CROSS REFERENCE TO RELATED APPLICATIONS

This application claims the benefit of U.S. provisional application Ser. No. 61/203,388, filed Dec. 22, 2008, the disclosure of which is incorporated by reference in its entirety.

### FIELD OF THE INVENTION

The present invention relates to polymer production, and more particularly, this invention relates to systems and methods for controlling properties of polymers produced in gas phase and liquid phase processes.

### BACKGROUND

In the gas phase process for production of polyolefins, a gaseous alkene (e.g., ethylene), hydrogen, co-monomer and other raw materials are converted to solid polyolefin (e.g., polyethylene) product. Generally, gas phase reactors include a fluidized bed reactor, a compressor, and a cooler (heat exchanger). The reaction is maintained in a two-phase fluidized bed of granular polyethylene and gaseous reactants by the fluidizing gas which is passed through a distributor plate near the bottom of the reactor vessel. Catalyst is added to the fluidized bed. Heat of reaction is transferred to the circulating gas stream. This gas stream is compressed and cooled in the external recycle line and then is reintroduced into the bottom of the reactor where it passes through a distributor plate. Make-up feedstreams are added to maintain the desired reactant concentrations.

The properties of the polymer formed by such a process can be controlled to some extent by varying the operating conditions, including the operating temperature, comonomer, type and quantity of catalyst, etc. Such properties include the molecular weight of the polymer product, the molecular weight distribution of the polymer product, polymer density and the flow index of the polymer product.

One method for controlling the molecular weight of a polymer product is to feed an adjunct material to the reactor system. For example, oxygen added to a gas phase fluidized bed polymerization system tends to function as a catalyst “poison” that terminates polymerization, generally resulting in a lower molecular weight of the polymer product. Oxygen also affects the molecular weight distribution of the polymer product. However, the catalyst productivity also suffers, making addition of oxygen to gas phase polymerization reactor systems undesirable. Therefore, it would be desirable to control the molecular weight of the product of a gas phase polymerization reaction while minimizing or avoiding the introduction of oxygen.

The properties of the polymer product as extracted from the reactor system, as well as in processed form for sale to customers, is also important. Typically, polymer product is extracted from the reactor and extruded into a more manageable form, such as pellets or bars. The flow index of a polymer product produced by a gas phase process using Cr-based catalysts, particularly those containing an aluminum alkyl such as diethyl aluminum ethoxide (DEALE) tend to show a decrease or otherwise downward shift in the flow index (a net increase in molecular weight) when passed through an extrusion line, as compared to the flow index of granular resin taken directly from the reactor. This difference in flow index between the extruded material and the raw product, or flow index “shift”, is typically small, amounting to only a few units, e.g., <2 dg/min, for Cr-based catalysts.

In some cases it is observed that the flow index of polymer particles of different size fractions vary substantially. When this variation is very large it is difficult to obtain reliable flow index data for the bulk material.

### SUMMARY

The present invention is broadly directed to various methods and systems for gas phase polymer production, including polyolefins such as polyethylene. The present invention is also broadly directed to various methods and systems for liquid phase polymer production, including polyolefins such as polyethylene. In certain embodiments, the methods are performed in conjunction with a polymerization reactor system such as gas phase or liquid phase reactor system. The invention is also broadly directed to various systems in which polymer properties are manipulated.

A method for producing a polymer according to one embodiment includes injecting a chromium oxide-based catalyst into a gas phase reactor system, contacting a gaseous monomer and optional comonomer(s) with the catalyst in the reactor system for polymerizing the monomer and optional comonomer to form a polymer; and adding an alkyl aluminum alkoxide such as diethylaluminum ethoxide (DEALE) in situ to the reactor system in an effective amount for decreasing a molecular weight of the polymer to about a target molecular weight.

A method for producing a polymer according to one embodiment includes injecting a chromium oxide-based catalyst that has been reduced with diethylaluminum ethoxide (DEALE) into a gas phase reactor system, contacting a gaseous monomer and optional comonomer with the catalyst in the reactor system for polymerizing the monomer and optional comonomer to form a polymer; and adding DEALE in situ to the reactor system in an effective amount for reducing a molecular weight of the polymer to about a target molecular weight.

A method for producing a polyolefin according to one embodiment includes determining an operating temperature for producing a polyolefin in a fluidized bed reactor system; selecting a chromium oxide-based catalyst that has been reduced with DEALE based on a desired property of the polyolefin and the operating temperature; contacting a monomer and optional comonomer with the catalyst in the fluidized bed reactor system; cooling a recycle stream of the fluidized bed reactor system for maintaining about the optimum operating temperature; adding DEALE in situ to the reactor system in an effective amount for reducing a molecular weight of the polymer to about a target molecular weight; measuring a flow index or melt index of the polymer; and adjusting a feed rate of the DEALE added in situ based on the measured flow index or melt index.

A method for producing a polyolefin according to one embodiment includes determining an initial operating temperature for producing a polyolefin in a fluidized bed reactor system; selecting a chromium oxide-based catalyst that has been reduced with DEALE based on a desired property of the polyolefin and the operating temperature; contacting a monomer and optional comonomer with the catalyst in the fluidized bed reactor system; cooling a recycle stream of the fluidized bed reactor system for maintaining about the initial operating temperature; adding DEALE in situ to the reactor system in an effective amount for reducing a molecular weight of the polymer to about a target molecular weight; measuring a flow index or melt index of the polymer; and increasing or decreasing the polymerization temperature based on the measured flow index or melt index while optionally adjusting a feed rate of the DEALE added in situ.

A method for producing a polyolefin according to one embodiment includes determining an initial set of operating conditions for producing a polyolefin in a fluidized bed reactor system including a temperature, a hydrogen concentration, an oxygen concentration and optionally a comonomer concentration; selecting a chromium oxide-based catalyst that has been reduced with DEALE based on a desired property of the polyolefin and the operating temperature; contacting a monomer with the catalyst in the fluidized bed reactor system; cooling a recycle stream of the fluidized bed reactor system for maintaining about the initial operating temperature; adding DEALE in situ to the reactor system in an effective amount for reducing a molecular weight of the polymer to about a target molecular weight; measuring a flow index or melt index of the polymer; and altering the initial set of operating conditions based on the measured flow index or melt index while optionally adjusting a feed rate of the DEALE added in situ.

A method for producing a polymer according to another embodiment includes adding a chromium oxide-based catalyst that has been reduced with DEALE to a liquid phase reactor system; contacting a monomer with the catalyst in the reactor system for polymerizing the monomer to form a polymer; and adding DEALE in situ to the reactor system in an effective amount for reducing a molecular weight of the polymer to about a target molecular weight.

A polymerization reactor system according to one embodiment includes a reactor vessel; a mechanism for operatively adding a chromium oxide-based catalyst to the reactor vessel; a mechanism for operatively adding a monomer to the reactor vessel, the monomer contacting the catalyst in the reactor vessel and forming a polymer; and a mechanism for operatively adding an alkyl aluminum alkoxide such as DEALE in situ to the reactor vessel in an effective amount for reducing a molecular weight of the polymer to about a target molecular weight.

A polymer product according to one embodiment includes a polymer characterized by having a flow index that does not vary by more than 3.5 times (300%) across the particle size fractions collected on sieve screens 18, 35 and 60 from the full screen set of 10, 18, 35, 60, 120, 200 US mesh.

A method for fabricating a polymer according to yet another embodiment includes injecting a chromium oxide-based catalyst into a gas phase reactor system; contacting a gaseous monomer with the catalyst in the reactor system for polymerizing the monomer to form a polymer; and adding DEALE in situ to the reactor system, wherein the polymer product is characterized as having a flow index that does not vary by more than 3.5 times (500%) across the particle size fractions collected on sieve screens 18, 35 and 60 from the full screen set of 10, 18, 35, 60, 120, 200 US mesh.

### BRIEF DESCRIPTION OF THE DRAWINGS

FIG. 1 is a schematic representation of certain embodiments of the invention illustrating implementation in a gas phase polymerization reactor system.

FIG. 2 is a graph of particle size distribution and flow index vs. screen size for a polymer product fabricated according to a comparative example.

FIG. 3 is a graph of particle size distribution and flow index vs. screen size for a polymer product fabricated according to one embodiment.

### DETAILED DESCRIPTION

Before the present compounds, components, compositions, and/or methods are disclosed and described, it is to be understood that unless otherwise indicated this invention is not limited to specific compounds, components, compositions, reactants, reaction conditions, ligands, catalyst structures, or the like, as such may vary. It is also to be understood that the terminology used herein is for the purpose of describing particular embodiments only and is not intended to be limiting.

As used in the specification and the appended claims, the singular forms “a,” “an” and “the” include plural referents unless otherwise specified.

It has been found that the continuous addition of a small amount of an alkyl aluminum alkoxide such as diethyl aluminum ethoxide (DEALE) as a separate component to an ongoing gas phase polymerization process utilizing chromium oxide-based catalyst (CrOx) causes the molecular weight to decrease (melt index increase). Thus, by adding a controlled amount of an alkyl aluminum alkoxide such as DEALE to the reactor system, one can manipulate the molecular weight of the product.

For ease of understanding and to place the teachings herein in a context, much of the present description is described in terms of DEALE. This is done by way of example only, and it should be understood that any alkyl aluminum alkoxide may be used in any embodiment instead of DEALE.

An alkyl aluminum alkoxide may be defined as a compound having the general formula R₂—Al—OR wherein R can be any of one to twelve carbon alkyl groups and OR is a one to twelve carbon alkoxy or phenoxy group. The R groups can be the same or different.

As used herein, “in catalyst” or “on catalyst”, in reference to the mode of addition of a component to the catalyst, is defined herein as addition directly to the catalyst prior to introduction of the catalyst to the reactor system. Therefore, when a component is added to the catalyst “in catalyst” or “on catalyst”, it is added to the other catalyst components prior to the transport of the aggregate to the reactor system.

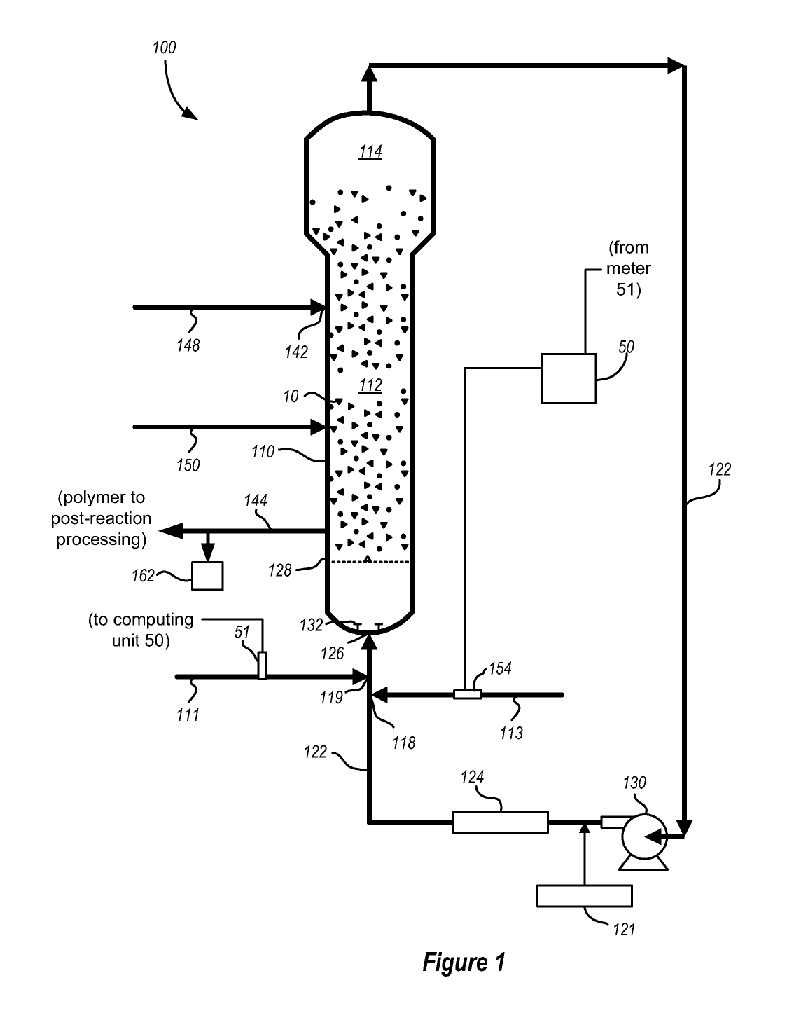

A general method of the invention can be described, for example, with reference to FIG. 1, in which a bulk material 10 is present in a gas phase polymerization reactor system 100. Such bulk material can be gaseous, liquid and/or solid material. In a reactor system, illustrative bulk materials may include one or more of reaction raw materials such as feedstocks, reaction products such as polymer particles, reaction adjuncts such as catalysts, reaction byproducts, etc., and other materials. Thus, the bulk material may include substantially pure individual materials as well as combinations of materials, the material(s) being present in one or more phases. A chromium oxide-based catalyst, which optionally may have been reduced with DEALE is added to the reactor system 100 via an appropriate mechanism such as feed line 148. A gaseous monomer, added to the system via an appropriate mechanism such as feed line 111, is contacted with the catalyst in the reactor system for polymerizing the monomer to form a polymer. DEALE is added in situ to the reactor system 100 via an appropriate mechanism such as feed line 148 or another feed line 150 in an effective amount for reducing a molecular weight of the polymer to about a target molecular weight.

In another preferred general approach of the general method described, for example, with reference to FIG. 1, a method for producing a polymer includes determining an operating temperature for producing a polyolefin in a fluidized bed reactor system, and selecting a chromium oxide-based catalyst which may optionally have been reduced with DEALE based on a desired property of the polyolefin and the operating temperature. A monomer is contacted with the catalyst in the fluidized bed reactor system. A recycle stream of the fluidized bed reactor system traveling through recycle line 122 is cooled, e.g., by a heat exchanger 124, for maintaining about the optimum operating temperature. DEALE is added in situ to the reactor system in an effective amount for reducing a molecular weight of the polymer to about a target molecular weight. Polymer is removed from the reactor vessel 110, and a flow index or melt index of the polymer is measured using techniques known in the art. A feed rate of the DEALE added in situ is adjusted based on the measured flow index or melt index, the flow or melt index being indicative of the molecular weight of the polymer. In some cases both the flow index shift found between the granular and extruded sample and the variation in flow index across polymer fractions separated by size can be significantly reduced.

Another general method of the invention can include the addition of a chromium oxide-based catalyst, which may optionally have been reduced with DEALE, to a liquid phase reactor system, contacting a monomer with the catalyst in the reactor system for polymerizing the monomer to form a polymer, and adding DEALE in situ to the reactor system in an effective amount for reducing a molecular weight of the polymer to about a target molecular weight.

Further details of fluidized bed and other gas phase polymerization reactor systems including specific materials used in the fabrication are described below, and each of the below-described details are specifically considered in various combinations with these and other generally preferred approaches described herein.

The present invention also includes devices and systems effective for producing polyolefins according to the aforementioned methods. In general, such devices are systems or apparatus that comprise one or more mechanisms for feeding DEALE into a polymerization reactor system.

For ease of understanding of the reader, as well as to place the various embodiments of the invention in a context, much of the following description shall be presented in terms of a commercial, gas phase polyethylene reactor system. It should be kept in mind that this is done by way of non-limiting example only.

As used herein, “in situ”, in reference to the mode of addition of a component to the reactor system, is defined herein as addition of the component to the reactor system. Therefore, when a catalyst is added in situ, it is added to the reactor system and is not combined with the other catalyst components to cause a chemical reaction therewith prior to their transport to the reactor. “In reactor” is synonymous with and used interchangeably herein with “in situ.”

### Addition of DEALE to Polymerization Reactor Systems

It has been found that the continuous addition of a small amount of DEALE as a separate component to an ongoing chromium oxide catalyzed gas phase polymerization process causes the molecular weight to decrease (melt index increase). Thus, by adding a controlled amount of DEALE to the reactor system, one can manipulate the molecular weight of the polymer. The DEALE addition also reduces the flow index shift. The flow index shift of a polymer is defined as the flow index of a processed (e.g., extruded, pelletized, etc.) polymer product minus the flow index of granular resin taken directly from the reactor system. The in situ addition of DEALE has also been observed to reduce the flow index variation versus polymer particle size compared to when the DEALE is added to the catalyst outside the reactor.

By using DEALE, catalyst poisons such as oxygen may not be needed to control the molecular weight; accordingly, the productivity of the catalyst is improved. For example, where DEALE is used to control molecular weight instead of oxygen in a CrOx catalyst based gas phase polyethylene polymerization reaction, catalyst productivity is expected to improve by about 15-20% or more, depending on the level of oxygen that would otherwise have been employed. As an additional benefit, it has been found that the resin particle size is increased, and the resin fines content is reduced, over similar processes employing oxygen.

It is believed that these findings extend beyond the use of DEALE and extend to other alkyl aluminum alkoxides.

### Reactor Systems and Reaction Processes

The inventive concepts described herein are applicable to polymerizations by any suspension, solution, slurry, or gas phase process, using known equipment and reaction conditions, and is not limited to any specific type of polymerization system. Thus, while various embodiments of the present invention are described in relation to gas phase polyolefin production, the broad concepts and teachings herein may also have applicability to many types of processes, including but not limited to, gas phase, gas/solid phase, liquid/solid phase, gas/liquid phase, and gas/liquid/solid phase reactor systems including polymerization reactor systems; gas phase, gas/solid phase, liquid/solid phase, gas/liquid phase, and gas/liquid/solid phase mass transfer systems; gas phase, gas/solid phase, liquid/solid phase, gas/liquid phase, and gas/liquid/solid phase mixing systems; etc.

The polymerization system may comprise a single reactor or two or more reactors in series, and is preferably conducted substantially in the absence of catalyst poisons. Organometallic compounds may be employed as scavenging agents for poisons to increase the catalyst activity. Examples of scavenging agents are metal alkyls, preferably aluminum alkyls. They may be fed in liquid form, liquid mixtures, or supported first on a solid support such as porous silica.

### Fluidized Bed Polymerization Reactor Systems

In each of the aforementioned generally preferred approaches and/or embodiments, a fluidized bed system can include a fluidized bed polymerization reactor system. As briefly noted above, gas phase polymerization reactions may be carried out in fluidized bed polymerization reactors, and can also be carried out in stirred or paddle-type reactor systems (e.g., stirred bed systems) which include solids in a gaseous environment. While the following discussion will feature fluidized bed systems, where the present invention has been found to be preferred and especially advantageous, it is to be understood that the general concepts relating to the addition of DEALE to manipulate the polymer molecular weight that is discussed relevant to the preferred fluidized bed systems, are also adaptable to the stirred or paddle-type reactor systems as well. The present invention is not limited to any specific type of gas phase reactor system.

A fluidized bed can generally include a bed of particles in which the static friction between the particles is disrupted. In each of the aforementioned generally preferred approaches and/or embodiments, the fluidized bed system is a closed fluidized bed system. The fluidized bed system can be a closed fluidized bed system. A closed fluidized bed system can comprise one or more fluids and one or more types of fluidized particles that are generally bounded by a barrier so that the fluids and particles are constrained. For example, a closed fluidized bed system may include a pipeline (e.g., for particle transport); a recirculating fluidized bed system, such as the fluidized bed polymerization reactor system of FIG. 1 (discussed above and below); or a solids drying system; any of which may be associated with various residential, commercial and/or industrial applications.

In general, the fluidized bed system can be defined by manufactured (e g., man-made) boundaries comprising one or more barriers. The one or more barriers defining manufactured boundaries can generally be made from natural or non-natural materials. Also, in general, the fluidized bed system (whether open or closed) can be a flow system such as a continuous flow system or a semi-continuous flow (e.g., intermittent-flow) system, a batch system, or a semi-batch system (sometimes also referred to as a semi-continuous system). In many instances, fluidized bed systems that are flow systems are closed fluidized bed systems.

The fluidized bed in preferred embodiments is generally formed by flow of a gaseous fluid in a direction opposite gravity. The frictional drag of the gas on the solid particles overcomes the force of gravity and suspends the particles in a fluidized state referred to as a fluidized bed. To maintain a viable fluidized bed, the superficial gas velocity through the bed must exceed the minimum flow required for fluidization. Increasing the flow of the fluidizing gas increases the amount of movement of the particles in the bed, and can result in a beneficial or detrimental tumultuous mixing of the particles. Decreasing the flow results in less drag on the particles, ultimately leading to collapse of the bed. Fluidized beds formed by gases flowing in directions other than vertically include particles flowing horizontally through a pipe, particles flowing downwardly e.g., through a downcomer, etc.

Fluidized beds can also be formed by vibrating or otherwise agitating the particles. The vibration or agitation keeps the particles in a fluidized state.

In general terms, a conventional fluidized bed polymerization process for producing resins and other types of polymers is conducted by passing a gaseous stream containing one or more monomers continuously through a fluidized bed reactor under reactive conditions and in the presence of catalyst at a velocity sufficient to maintain the bed of solid particles in a suspended condition. A continuous cycle is employed where the cycling gas stream, otherwise known as a recycle stream or fluidizing medium, is heated in the reactor by the heat of polymerization. The hot gaseous stream, also containing unreacted gaseous monomer, is continuously withdrawn from the reactor, compressed, cooled and recycled into the reactor. Product is withdrawn from the reactor and make-up monomer is added to the system, e.g., into the recycle stream or reactor vessel, to replace the polymerized monomer. See for example U.S. Pat. Nos. 4,543,399, 4,588,790, 5,028,670, 5,317,036, 5,352,749, 5,405,922, 5,436,304, 5,453,471, 5,462,999, 5,616,661, 5,668,228, and 6,689,847. FIG. 1 illustrates a basic, conventional fluidized bed system where the reactor vessel 110 comprises a reaction zone 112 and a velocity reduction zone 114. While a reactor configuration comprising a generally cylindrical region beneath an expanded section is shown in FIG. 1, alternative configurations such as a reactor configuration comprising an entirely or partially tapered reactor may also be utilized. In such configurations, the fluidized bed can be located within a tapered reaction zone but below a region of greater cross-sectional area which serves as the velocity reduction zone of the more conventional reactor configuration shown in FIG. 1.

In general, the height to diameter ratio of the reaction zone can vary in the range of about 2.7:1 to about 5:1. The range may vary to larger or smaller ratios and depends mainly upon the desired production capacity. The cross-sectional area of the velocity reduction zone 114 is typically within the range of from about 2.5 to about 2.9 multiplied by the cross-sectional area of the reaction zone 112.

The reaction zone 112 includes a bed of growing polymer particles, formed polymer particles and a minor amount of catalyst all fluidized by the continuous flow of polymerizable and modifying gaseous components, including inerts, in the form of make-up feed and recycle fluid through the reaction zone. To maintain a viable fluidized bed, the superficial gas velocity through the bed must exceed the minimum flow required for fluidization which is typically from about 0.2 to about 0.5 ft/sec. for polyolefins. Preferably, the superficial gas velocity is at least 0.2 ft/sec above the minimum flow for fluidization or from about 0.4 to about 0.7 ft/sec. Ordinarily, the superficial gas velocity will not exceed 5.0 ft/sec and is usually no more than about 2.5 ft/sec.

On start-up, the reactor is generally charged with a bed of particulate polymer particles before gas flow is initiated. Such particles help to prevent the formation of localized “hot spots” when catalyst feed is initiated. The particles may be the same as the polymer to be formed or different. When different, they are preferably withdrawn with the desired newly formed polymer particles as the first product. Eventually, a fluidized bed consisting of desired polymer particles supplants the start-up bed.

Fluidization is achieved by a high rate of fluid recycle to and through the bed, typically on the order of about 50 times the rate of feed or make-up fluid. This high rate of recycle provides the requisite superficial gas velocity necessary to maintain the fluidized bed. The fluidized bed has the general appearance of a dense mass of individually moving particles as created by the percolation of gas through the bed. The pressure drop through the bed is equal to or slightly greater than the weight of the bed divided by the cross-sectional area.

Referring again to FIG. 1, make-up fluids can be fed at points 118 and 119 via recycle line 122. The composition of the recycle stream is typically measured by a gas analyzer 121 and the composition and amount of the make-up stream is then adjusted accordingly to maintain an essentially steady state composition within the reaction zone. The gas analyzer 121 can be positioned to receive gas from a point between the velocity reduction zone 114 and heat exchanger 124, preferably, between compressor 130 and heat exchanger 124.

To ensure complete fluidization, the recycle stream and, where desired, at least part of the make-up stream can be returned through recycle line 122 to the reactor, for example at inlet 126 below the bed. Preferably, there is a gas distributor plate 128 above the point of return to aid in fluidizing the bed uniformly and to support the solid particles prior to start-up or when the system is shut down. The stream passing upwardly through and out of the bed helps remove the heat of reaction generated by the exothermic polymerization reaction.

The portion of the gaseous stream flowing through the fluidized bed which did not react in the bed becomes the recycle stream which leaves the reaction zone 112 and passes into the velocity reduction zone 114 above the bed where a major portion of the entrained particles drop back onto the bed thereby reducing solid particle carryover. The recycle stream is then compressed in compressor 130 and passed through heat exchanger 124 where the heat of reaction is removed from the recycle stream before it is returned to the bed. Note that the heat exchanger 124 can also be positioned before the compressor 130. An illustrative heat exchanger 124 is a shell and tube heat exchanger, with the recycle gas traveling through the tubes.

The recycle stream exiting the heat exchange zone is then returned to the reactor at its base 126 and thence to the fluidized bed through gas distributor plate 128. A fluid flow deflector 132 is preferably installed at the inlet to the reactor to prevent contained polymer particles from settling out and agglomerating into a solid mass and to maintain entrained or to re-entrain any particles or liquid which may settle out or become disentrained.

In FIG. 1, polymer product is discharged from line 144. Although not shown, it is desirable to separate any fluid from the product and to return the fluid to the reactor vessel 110.

In accordance with an embodiment of the present invention, the polymerization catalyst enters the reactor in solid or liquid form at a point 142 through line 148. The one or more cocatalysts to be added may be introduced separately into the reaction zone where they will react with the catalyst to form the catalytically active reaction product and/or affect the reaction proceeding in the reactor system. However the catalyst and cocatalyst(s) may be mixed prior to their introduction into the reaction zone.

The reactor shown in FIG. 1 is particularly useful for forming polyolefins such as polyethylene and/or polypropylene. Process conditions, raw materials, catalysts, etc. for forming various polyolefins and other reaction products are found in the references incorporated herein. Illustrative process conditions for polymerization reactions in general are listed below to provide general guidance.

The reaction vessel, for example, has an inner diameter of at least about 2 feet, and is generally greater than about 10 feet, and can exceed 15 or 17 feet.

The reactor pressure in a gas phase process may vary from about 100 psig (690 kPa) to about 600 psig (4138 kPa), preferably in the range of from about 200 psig (1379 kPa) to about 400 psig (2759 kPa), more preferably in the range of from about 250 psig (1724 kPa) to about 350 psig (2414 kPa).

The reactor temperature in a gas phase process may vary from about 30° C. to about 120° C. In one approach, the reactor temperature is less than about 40° C., 30° C., more preferably less than about 20° C., and even more preferably less than about 15° C. below the melting point of the polyolefin being produced. The process can run at even higher temperatures, e.g., less than about 10° C. or 5° C. below the melting point of the polyolefin being produced. Polyethylene, for example, has a melting point in the range of approximately 125° C. to 130° C.

The overall temperature in a gas phase process typically varies from about 30° C. to about 125° C. In one approach, the temperature at the point of highest temperature in the reactor system is less than about 30° C., more preferably less than about 20° C., and even more preferably less than about 15° C. below the melting point of the polyolefin being produced. In a system such as that shown in FIG. 1, the point of highest temperature is typically at the outlet of the compressor 130.

Other gas phase processes contemplated include series or multistage polymerization processes. Also gas phase processes contemplated include those described in U.S. Pat. Nos. 5,627,242, 5,665,818 and 5,677,375, and European publications EP-A-0 794 200, EP-B1-0 649 992, EP-A-0 802 202, and EP-B-634 421.

In any of the embodiments described herein, the gas phase process may be operated in a condensed mode, where an inert condensable fluid is introduced to the process to increase the cooling capacity of the reactor system. These inert condensable fluids are referred to as induced condensing agents or ICA's. For further details of a condensed mode processes see U.S. Pat. Nos. 5,342,749 and 5,436,304.

In an embodiment, the reactor utilized is capable of producing greater than 500 lbs of polymer per hour (227 Kg/hr) to about 300,000 lbs/hr (136,100 Kg/hr) or higher of polymer, or greater than 1000 lbs/hr (454 Kg/hr), preferably greater than 10,000 lbs/hr (4540 Kg/hr), more preferably greater than 25,000 lbs/hr (11,300 Kg/hr), still more preferably greater than 35,000 lbs/hr (15,900 Kg/hr), even more preferably greater than 50,000 lbs/hr (22,700 Kg/hr), and most preferably greater than 65,000 lbs/hr (29,500 Kg/hr) to greater than 100,000 lbs/hr (45,400 Kg/hr).

In some embodiments a fluidized bed polymerization reactor system that includes a recirculating system including a fast riser, a downcomer, and a recirculating pump, may be used. In this type of system, the polymerization product is formed primarily in the fast riser, but continues to form throughout the system. Polymer particles formed in the fast riser pass through a line to an upper inlet port of the downcomer. The polymer particles gather in the downcomer, where they move downwardly in a dense, slow moving bed. The bed formed in the downcomer can be considered a fluidized bed.

### Liquid Phase Reactor Systems

In some embodiments, a liquid phase polymerization system, such as a slurry, suspension or solution reactor system may be used. Such a system generally comprises a reactor vessel to which an olefin monomer and a catalyst composition are added, individually or as a mixture combined prior to addition to the reactor vessel. The reactor vessel typically contains a liquid reaction medium for dissolving and/or suspending the polyolefin. The liquid reaction medium may consist of the bulk liquid monomer or an inert liquid hydrocarbon that is nonreactive under the polymerization conditions employed. Although such an inert liquid hydrocarbon need not function as a solvent for the catalyst composition or the polymer obtained by the process, it usually serves as solvent for the monomers employed in the polymerization. Among the inert liquid hydrocarbons suitable for this purpose are isobutane, isopentane, hexane, cyclohexane, heptane, benzene, toluene, and the like. Slurry or solution polymerization systems may utilize subatmospheric or superatmospheric pressures and temperatures in the range of about 40° C. to about 300° C. A useful liquid phase polymerization system is described in U.S. Pat. No. 3,324,095.

Reactive contact between the olefin monomer and the catalyst composition may be maintained by constant stirring or agitation, e.g., by a member such as a paddle or plunger rotating or moving through the reactor vessel (e.g., stirred reactor, blender, etc.). Other types of liquid phase polymerization systems can be formed by a rotating drum (e.g., with or without internal baffles to enhance mixing), a vessel moving in a see-saw manner, agitation including ultrasonic vibrations applied to the materials or vessel, etc.

### Fluids

In general, for example, the reactor systems and methods described herein can be used in connection with liquids and/or gases having a wide range of fluid properties, such as a wide range of viscosities, densities and/or dielectric constants (each such property being considered independently or collectively as to two or more thereof). For example, liquid fluids can generally have viscosities ranging from about 0.1 cP to about 100,000 cP, and/or can have densities ranging from about 0.0005 g/cc³ to about 20 g/cc³ and/or can have a dielectric constant ranging from about 1 to about 100. In many embodiments of the invention, the bulk material is a gaseous fluid. Gaseous fluids can, for example, generally have viscosities ranging from about 0.001 to about 0.1 cP, and/or can have densities ranging from about 0.0005 to about 0.1 g/cc³ and/or can have a dielectric constant ranging from about 1 to about 1.1.

The bulk material can include relatively pure gaseous elements (e.g., gaseous N₂, gaseous H₂, gaseous O₂). Other components can include relatively pure liquid, solid, or gaseous compounds (e.g., liquid or solid catalyst, gaseous monomers). The various systems of the inventions can also include single-phase or multi-phase mixtures of gases, solids and/or liquids, including for example: two-phase mixtures of solids and gases (e.g., fluidized bed systems), mixtures of gases with a single type of particle, mixtures of gases with different types of particles (e.g., polymer and catalyst particles); and/or three-phase mixtures of gases, liquids and solids (e.g., fluidized bed with liquid catalyst being added or liquid monomer or other liquid compound). Particular examples of preferred fluids are described herein, including in discussion below regarding preferred applications of the methods and devices of the invention.

### Hydrogen

In generally preferred embodiments, the amount of hydrogen fed to the reactor system maintains in the fluidized bed reactor system about a molar ratio of hydrogen to monomer of between 0 and about 0.5 mol/mol. In other embodiments, hydrogen is fed to the reactor system to maintain in the fluidized bed reactor system about a molar ratio of hydrogen to monomer of between 0 and about 0.25 mol/mol, between 0 and about 0.1 mol/mol, and between 0 and about 0.05 mol/mol.

In some embodiments oxygen may be intentionally added as a catalyst modifier in amounts generally ranging from about 1 ppb by volume to about 500 ppb by volume.

### Catalysts

The catalysts and catalyst systems that may be used include chromium-based catalysts and reduced chromium oxide-based catalysts.

The so-called Phillips catalyst, introduced in the early 1960s was the first chromium oxide-on-silica catalyst. The catalyst is formed by impregnating a Cr⁺³ species into silica, followed by fluidization of the silica matrix at ca. 400° C.-900 C. Under these conditions, Cr⁺³ is converted to Cr⁺⁶. The Phillips catalyst is also commonly referred to in the prior art as “inorganic oxide-supported Cr⁺⁶.”

Variations on catalysts employing Cr⁺⁶ species supported on silica are also known. One particular variation uses titanium tetraisopropoxide impregnated onto silica along with the Cr⁺³ species before activation. This variation is hereinafter referred to as “Ti—CrOx” (titanated chromium oxide). Such modifications result in polyethylenes with slightly greater molecular weight distributions compared to those made without titanation.

Aluminum alkyl reduced chromium oxide-on-silica (CrOx) catalysts represent one pathway to improved catalyst systems for polyethylenes and other polyolefins. It is desired that any such catalytic system perform well during high space-time yield operation (i.e., operation maximizing polymer produced per unit reactor time and reactor space), producing the greatest amount of polyethylene possible with high catalyst activity in a shorter residence time.

Information about these and other types of catalysts, including methods of preparation for chromium oxide-based catalysts, as well as characteristics of the polymer products formed is found in U.S. Pat. No. 6,989,344.

A chromium oxide-based catalyst reduced with a reducing agent will have certain properties based on the ratio of reducing agent to chromium. The stated equivalents noted herein are always the ratio of reagent to chromium. In a preferred embodiment, a chromium oxide-based catalyst used for polyolefin, e.g., polyethylene, applications includes a silica supported chromium oxide reduced with DEALE. This type of catalyst provides a polyethylene with a broad molecular weight distribution.

As noted above, DEALE may be added in situ to the reactor system in an effective amount for decreasing molecular weight of the polymer to about a target molecular weight. DEALE is typically fed to the reactor system in a liquid carrier.

In various approaches, the feed rate of the DEALE added in situ may be fixed, or may vary based on some variable.

In one approach, the feed rate of the DEALE added in situ may vary with the feed rate of the monomer to maintain a predetermined ratio of feed rate of the DEALE to the feed rate of the monomer. In generally preferred embodiments, the feed rate of the DEALE is set to about a predetermined ratio of a feed rate of a monomer. For example, the DEALE added in situ may be fed to the reactor system at a rate equivalent to less than about 60 parts per million weight (ppmw) of DEALE relative to the weight of monomer added to the fluidized bed reactor system, such as less than 60, 50, 40, 30, 20, 15, 10, 5, 1, 0.50, 0.25, 0.10, 0.075, 0.05 ppmw.

In one approach, the feed rate of the DEALE added in situ may vary with the polymer production rate to maintain a predetermined ratio of feed rate of the DEALE to the feed rate of the monomer. This is similar to the previous approach based on monomer feed rate because polymer production rate and monomer feed rate are can be nearly equal. In generally preferred embodiments, the feed rate of the DEALE is set to about a predetermined ratio of the polymer production rate. For example, the DEALE added in situ may be fed to the reactor system at a rate equivalent to less than about 60 parts per million weight (ppmw) of DEALE relative to the polymer production rate in the reactor system, such as less than 60, 50, 40, 30, 20, 15, 10, 5, 1, 0.50, 0.25, 0.10, 0.075, 0.05 ppmw.

In another approach, the feed rate of the DEALE in situ is selected relative to the amount of Cr (in the catalyst) being added to the system. For instance, the DEALE added in situ may be fed to the reactor system at a rate equivalent to create a DEALE (in situ, excludes DEALE on catalyst) to Cr molar ratio of between about 0.05 and about 10, such as 10, 5, 1, 0.50, 0.25, 0.10, 0.075, 0.05 mol/mol. The DEALE (in situ)/Cr molar ratio of materials entering via the feed streams and/or in the reactor system itself may be varied or kept about constant during operation of the reactor system. This can be accomplished by adding a catalyst having a different DEALE (in catalyst)/Cr ratio, changing the amount of catalyst and/or DEALE (in situ) added, etc.

In yet another approach, the amount of DEALE added in situ is based on a measured flow index of the polymer, the flow index being indicative of a molecular weight of the polymer. If the flow index indicates that the polymer molecular weight is above a target level, the feed rate of the DEALE added in situ can be increased to reduce the molecular weight of the polymer. Conversely, if the flow index indicates that the polymer molecular weight is below a target level, the feed rate of the DEALE added in situ can be reduced to increase the molecular weight of the polymer.

In one embodiment, a method for producing a polyolefin includes determining an initial operating temperature for producing a polyolefin in a fluidized bed reactor system; selecting a chromium oxide-based catalyst that has been reduced with diethylaluminum ethoxide (DEALE) based on a desired property of the polyolefin and the operating temperature; contacting a monomer and optional comonomer with the catalyst in the fluidized bed reactor system; cooling a recycle stream of the fluidized bed reactor system for maintaining about the initial operating temperature; adding DEALE in situ to the reactor system in an effective amount for reducing a molecular weight of the polymer to about a target molecular weight; measuring a flow index or melt index of the polymer; and increasing or decreasing the polymerization temperature based on the measured flow index or melt index while optionally adjusting a feed rate of the DEALE added in situ.

In another embodiment, a method for producing a polyolefin includes determining an initial set of operating conditions for producing a polyolefin in a fluidized bed reactor system including a temperature, a hydrogen concentration, an oxygen concentration and optionally a comonomer concentration; selecting a chromium oxide-based catalyst that has been reduced with diethylaluminum ethoxide (DEALE) based on a desired property of the polyolefin and the operating temperature; contacting a monomer with the catalyst in the fluidized bed reactor system; cooling a recycle stream of the fluidized bed reactor system for maintaining about the initial operating temperature; adding DEALE in situ to the reactor system in an effective amount for reducing a molecular weight of the polymer to about a target molecular weight; measuring a flow index or melt index of the polymer; and altering at least one condition from the initial set of operating conditions based on the measured flow index or melt index while optionally adjusting a feed rate of the DEALE added in situ.

The foregoing parameters are generally applicable to both gas phase and liquid based reactor systems.

### Operating Conditions

The operating conditions of the reactor and other systems are not narrowly critical to the invention in some embodiments. While general operating conditions have been provided above for fluidized bed polymerization reactor systems, fluidized and nonfluidized bed systems can, in addition to those listed above, have widely varying process conditions, such as temperature, pressure, fluid flowrate, etc.

The operating conditions of the reactor and other systems are critical to the invention in other embodiments. For example, higher operating temperatures generally result in a higher production rate. Therefore, an aspect of the present invention uses a high operating temperature in order to obtain a high production rate. A catalyst may be selected to produce a desired product at the selected optimum temperature. The amount of DEALE added in situ and/or hydrogen added to the system is selected as set forth herein.

As mentioned above, preferred embodiments operate at an optimum temperature to maximize the production rate and/or to obtain about a target molecular weight and molecular weight distribution of the polymer. The optimum operating temperature, of course, is a relative term, as the temperature at various points in the reactor system will be different. Therefore, the optimum operating temperature may be based on a temperature in the fluidized bed, in a recycle stream (before or after the heat exchanger), etc. The optimum operating temperature can also be based on an average of preferred temperatures at various points in the system.

Considerations when selecting the optimum temperature include functionality of the catalyst at a given temperature and the melting point of the polymer product.

In generally preferred embodiments, the optimum temperature will fall within the ranges provided above.

### Computing Unit(s)

With reference to FIG. 1, a computing unit 50 may control various aspects of the reactor system, automatically and/or as directed by a user. The computing unit 50 may be a simple monitoring device that generates a process control signal based on an incoming signal from another system component or from a user. More complex computing units are also contemplated, such as computerized systems. The computing unit 50 may be coupled to other system components such as process controllers, flow meters on the various feed and outlet lines, indexers 162, gas analyzer 121, etc.

In preferred embodiments, one or more circuit modules of the computing unit 50 can be implemented and realized as an application specific integrated circuit (ASIC). Portions of the processing can also be performed in software in conjunction with appropriate circuitry and/or a host computing system.

As noted above, the flow rate of DEALE added to the system may be dependent upon a flow rate or molar feed rate of another component, such as the monomer. The computing unit 50 may thus automatically control the feed rate of the DEALE added to the system. As shown in FIG. 1, the computing unit 50 may be coupled a flow meter 51 on the monomer feed line 111. The computing unit receives a signal from the flow meter 51 indicative of a flow rate of monomer passing through line 111. The computing unit then calculates the appropriate volumetric, molar, etc. feed rate of the monomer feed or component thereof, calculates the proper amount of DEALE to add to the system, and adjusts the flow rate of DEALE via flow control valves 154, etc as the monomer feed rate changes

In another aspect, the computing unit 50 may receive a flow index measurement, or derivative thereof, for the polymer exiting the system. The measurement, or derivative thereof, may be received directly from an indexer 162, via user input, or both. The computing unit may then compute an amount of DEALE to add to the system based on the flow index measurement, or derivative thereof.

Similarly, the computing unit 50 may receive flow index measurements, or derivatives thereof, for the polymer exiting the system and for processed polymer. The computing unit may then compute an amount of DEALE to add to the system based on the flow index measurements, or derivatives thereof.

### Products

Polyolefins that may be produced according to the invention include, but are not limited to, those made from olefin monomers such as ethylene and linear or branched higher alpha-olefin monomers containing 3 to about 20 carbon atoms. Homopolymers or interpolymers of ethylene and such higher alpha-olefin monomers, with densities ranging from about 0.90 to about 0.965 may be made. Suitable higher alpha-olefin monomers include, for example, propylene, 1-butene, 1-pentene, 1-hexene, 4-methyl-1-pentene, 1-octene, and 3,5,5-trimethyl-1-hexene. Specific polyolefins that may be made include, for example, high density polyethylene, medium density polyethylene (including ethylene-butene copolymers and ethylene-hexene copolymers) homo-polyethylene, and polypropylene.

### Post-Reaction Processing

The post-reaction processing may include pelletizing the polymer created in the reactor system. Such pelletization processes, known in the art, include extruding the raw polymer through a narrow aperture, upon which the extruded polymer is cut into pellets. The polymer may be heated to facilitate extrusion. Prior to extrusion, additives may be added to the polymer.

In another approach, the polymer is processed to form extruded strands.

In a further approach, the polymer granules are compressed into a larger composite block.

Those skilled in the art will appreciate that other forms of post-reaction processing may be performed.

### Flow and Melt Index Measurement

The flow index is a measure of the ease of flow of the melt of a thermoplastic polymer. It is defined as the weight of polymer in grams flowing in 10 minutes through a capillary of specific diameter and length by a pressure applied via prescribed alternative gravimetric weights for alternative prescribed temperatures. The flow index is an indirect measure of molecular weight, high flow index corresponding to low molecular weight.

Related to the flow index is the melt index. The melt index is also indicative of a molecular weight of the polymer under test.

For polyethylene, the melt index (I₂) may be determined under ASTM D-1238, Condition FR-190/2.16. Melt flow rate (I₅) can be determined under ASTM D-1238, Condition FR-190/5.0. Flow index (I₂₁) may be determined under ASTM D-1238, Condition FR-190/21.6.

Flow and melt index tests may be conducted using a commercial indexer 162 (FIG. 1). Illustrative indexers are indexer models MP200 and MP600 from Tinius Olsen, Inc., 1065 Easton Road, PO Box 1009, Horsham, Pa. 19044-8009, USA.

Ratios between two flow index values for one material at different gravimetric weights may be used as a measure for the broadness of the molecular weight distribution.

It should be kept in mind that various steps performed in the methodology presented herein may be performed in any combination in each of the various combinations and permutations of the present invention.

### EXAMPLES

It is to be understood that while the invention has been described in conjunction with the specific embodiments thereof, the foregoing description is intended to illustrate and not limit the scope of the invention. Other aspects, advantages and modifications will be apparent to those skilled in the art to which the invention pertains.

Therefore, the following examples are put forth so as to provide those skilled in the art with a complete disclosure and description and are not intended to limit the scope of that which the inventors regard as their invention.

Catalysts Employed in the Examples were Prepared as Follows

### Example 1

Catalyst A: Chromium oxide on titanated silica. About 500 grams of a porous silica support containing 2.5 weight percent chromium acetate, which amounts to 0.5% Cr content (Grade 957HS chromium on silica, produced by Davison Catalyst division of W. R. Grace and Co., having a sales office at Irondale, Ala., USA) having a particle size of about 40 microns and a surface area of about 300 square meters per gram were dried by passing a stream of nitrogen through it for about 4 hours at about 150° C. About 400 grams of the dried supported chromium compound were then slurried in about 2330 ml of dry isopentane, and then 96 grams of tetraisopropyl titanate were added to the slurry. The system was mixed thoroughly and then isopentane was removed by heating the reaction vessel. The dried material was then transferred to a heating vessel where it was heated under dry nitrogen at 325° C. for about 2 to 4 hours to ensure that all the isopentane was removed and to slowly remove any organic residues from the tetraisopropyl titanate so as to avoid any danger of an explosive mixture within the vessel in the next step. The nitrogen stream was then replaced with a stream of dry air and the catalyst composition was heated slowly at a rate of about 50° C. per hour or 100° C. per hour to 550° C. where it was activated for about 6 hours. The activated catalyst was then cooled with dry air (at ambient temperature) to about 300° C. and further cooled from 300° C. to room temperature with dry nitrogen (at ambient temperature). Catalysts made using this procedure and employed in the examples had a composition of about 0.5 wt % chromium and about 3.8 wt % titanium.

### Example 2

Catalyst B: Chromium oxide catalyst on C35300MS support. About 1 kg of a porous silica support containing about 5 weight percent chromium acetate (Grade C35300MS chromium on silica, produced by PQ Corporation having a sales office in Malvern, Pa., USA), which amounts to about 1 weight percent Cr content, having a particle size of about 90 microns and a surface area of about 500 square meters per gram was charged to a fluidized bed heating vessel. There it was heated slowly at a rate of about 50° C. per hour under dry nitrogen up to 200° C. and held at that temperature for about 4 hours. Next it was heated slowly at a rate of about 50° C. per hour under dry nitrogen up to 450° C. and held at that temperature for about 2 hours. The nitrogen stream was then replaced with a stream of dry air and the catalyst composition was heated slowly at a rate of about 50° C. per hour to 600° C. where it was activated for about 6 hours. The activated catalyst was then cooled with dry air (at ambient temperature) to about 300° C. and further cooled from 300° C. to room temperature with dry nitrogen (at ambient temperature). The resulting cooled powder was stored under nitrogen atmosphere until treated with a reducing agent as described below.

### Example 3

Catalyst C and D: Catalyst reduction. In a typical chromium oxide catalyst reduction, the Catalyst B was placed in a vertical catalyst blender with a helical ribbon agitator under an inert atmosphere. Degassed and dried hexane or isopentane solvent was added to adequately suspend the supported catalyst. About 7.1 liters of solvent were charged per kilogram of support (0.89 gallons per pound). DEALE, available from Akzo Nobel having a sales office in Chicago, Ill., USA, and obtained as a 25 wt % solution in isopentane or hexane, was then added to the surface of the catalyst slurry at a selected rate over a selected time period to obtain a selected amount of DEALE. The mixture was agitated at a selected agitation rate at a temperature of approximately 45° C. during the selected addition time. The mixture was further agitated at a controlled rate for about 2 hours. Then the solvent was substantially removed by drying at a jacket temperature of approximately 70° C. and slightly above atmospheric pressure for about 14 to 18 hours. The resulting dry, free flowing powder was then stored under nitrogen until used. Information about the catalysts produced by this method is found in U.S. Pat. No. 6,989,344, which has been incorporated by reference above.

Results for examples 4-14 are shown in Table 1. Details of each example are presented below.

TABLE 1

| | | | Process Conditions | | | | | | | | | | | Product | | |
|---|---|---|---|---|---|---|---|---|---|---|---|---|---|---|---|---|
| | | | | | H2/ | C6/ | | | | | | | Pro- | | | |
| | | | | Re- | C2 | C2 | | | | | Resi- | STY | duc- | | | Flow |
| | | | | actor | (gas | (gas | Oxy- | | Cocatalyst | Cocatalyst | dence | (lb/ | tion | Resin | Den- | Index |
| | | Cata- | DEALE | Temp | mole | mole | gen | | Conc. | Al/Cr | Time | hr/ | Rate | APS | sity | (dg/ |
| Example | | lyst | (wt %) | (C.) | ratio) | ratio) | (ppb) | Cocatalyst | (ppmw) | Ratio | (hr) | ft3) | (lb/hr) | (in) | (g/cc) | min) |
| 4 | Comp | Cat A | 0 | 95 | 0.05 | 0.0044 | 151 | TEAL | 0.22 | 0.15 | 2.1 | 6.9 | 58 | | 0.9487 | 9.86 |
| 5 | Inv | Cat A | 0 | 95 | 0.05 | 0.0053 | 0 | DEALE | 3.76 | 2.55 | 2.3 | 6.3 | 63 | | 0.9491 | 10.67 |
| 6 | Comp | Cat C | 8.62 | 102.0 | 0.120 | 0.0085 | 20.1 | None | | | 2.43 | 8.27 | 65.2 | 0.0395 | 0.9457 | 8.84 |
| 7 | Comp | Cat C | 8.62 | 97.0 | 0.135 | 0.0105 | 50.1 | None | | | 1.97 | 9.42 | 75.5 | 0.0369 | 0.9457 | 8.6 |
| 8 | Inv | Cat B | 0 | 97.0 | 0.050 | 0.0081 | 20.2 | DEALE | 27.2 | 6.32 | 2.50 | 6.17 | 58.0 | 0.0389 | 0.9500 | 6.96 |
| 9 | Inv | Cat B | 0 | 97.0 | 0.050 | 0.0111 | 20.1 | DEALE | 24.8 | 4.54 | 2.31 | 7.32 | 63.2 | 0.0397 | 0.9469 | 10.1 |
| 10 | Comp | Cat D | 6.18 | 98.2 | 0.040 | 0.0100 | 25.1 | None | — | — | 2.19 | 8.20 | 68.7 | 0.0396 | 0.9431 | 5.9 |
| 11 | Comp | Cat D | 6.18 | 104.0 | 0.040 | 0.0068 | 41.9 | None | — | — | 2.22 | 7.91 | 65.9 | 0.0378 | 0.9450 | 10.6 |
| 12 | Inv | Cat D | 6.18 | 98.0 | 0.040 | 0.0100 | 25.1 | DEALE | 3.55 | 0.98 | 2.18 | 8.29 | 69.3 | 0.0390 | 0.9471 | 10.1 |
| 13 | Inv | Cat D | 6.18 | 98.0 | 0.040 | 0.0106 | 25.1 | DEALE | 2.13 | 0.62 | 2.18 | 8.42 | 70.0 | 0.0417 | 0.9453 | 9.2 |
| 14 | Inv | Cat D | 6.18 | 98.0 | 0.040 | 0.0110 | 25.1 | DEALE | 1.4 | 0.39 | 2.22 | 8.45 | 69.9 | 0.0395 | 0.9437 | 8.1 |

### General Polymerization Procedure:

Examples were conducted continuously in the fluidized-bed reactor. Cycle gas was circulated through the reactor and heat of reaction was removed in a heat exchanger. Catalyst powder was continuously introduced into the fluidized bed. Monomers, hydrogen and oxygen were fed into the cycle gas piping. Product was transferred intermittently into a product chamber, depressurized, degassed briefly, and then discharged into a drum. The drum contained butylated hydroxytoluene, an antioxidant stabilizer, as a temporary storage stabilizer, and was treated with a stream of moist nitrogen. Certain conditions in the fluidized-bed reactor were maintained at a constant value or in a narrow range. Ethylene partial pressure was about 200 psi. The H₂/C₂ molar gas ratio in the cycle gas was varied. Total reactor pressure was 360-390 psia. Superficial gas velocity within the fluidized bed was 1.7-2.0 ft/s. Reactions were conducted in a similar manner to that found in U.S. Pat. No. 6,989,344, which is herein incorporated by reference.

Example 4 is a comparative example which shows the flow index of polymer made with a catalyst A under a certain set of reaction conditions. A flow index of 10 was achieved employing 151 ppb of oxygen. A small amount of triethyl aluminum was added to the reactor to maintain continuous operation but had little effect on the flow index of the polymer.

Example 5 shows that under virtually identical conditions as shown in Example 4 no oxygen was required when DEALE was added to the reactor and the flow index was actually increased. This shows that DEALE can control the flow index of the polymer without altering reaction conditions.

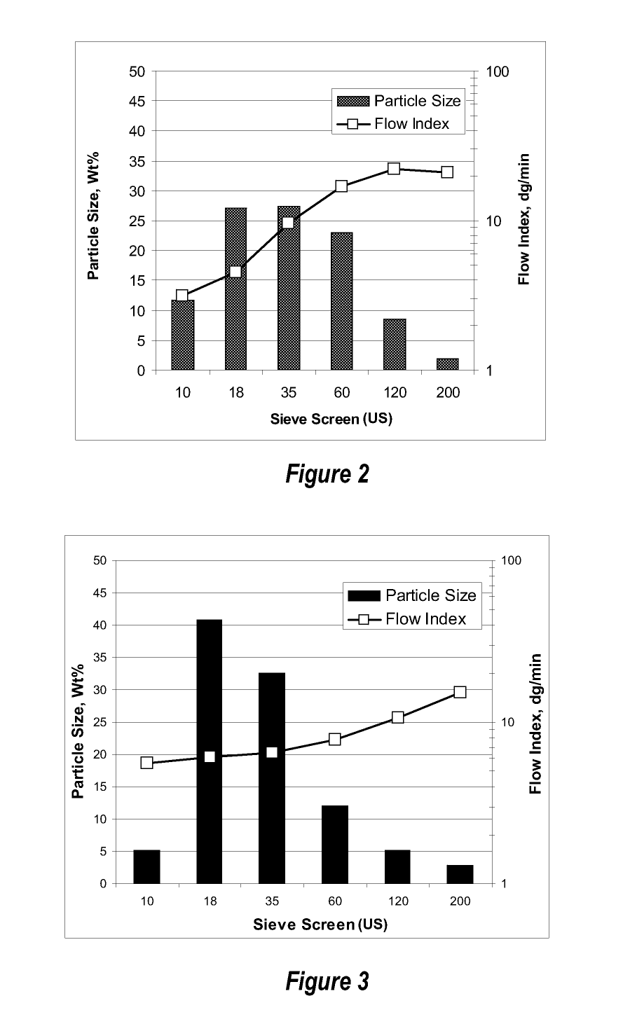

In comparative Examples 6 and 7, a polymer with about 8-9 flow index was produced with Catalyst C (DEALE reduced silica supported chromium oxide) under these reaction conditions. Either higher reaction temperature or higher H2/C2 or oxygen was required to obtain the flow index value. FIG. 2 shows that there was a large change in flow index versus particle size for Example 6. Larger particles have lower flow index values, while small particles have higher flow index values.

Examples 8 and 9 show that lower reaction temperatures and oxygen levels were used to obtain flow index values similar to those found in Examples 6 and 7 when DEALE was introduced into the reactor with a chromium oxide catalyst that was not reduced prior to introduction into the reactor. In addition, the variation in flow index versus particle size was significantly reduced in Example 9, as illustrated in FIG. 5. Accordingly, in some approaches where the chromium-oxide based catalyst does not include DEALE, a flow index of the polymer vs. particle size of the polymer (as in FIG. 5) varies less than a flow index vs. particle size of a polymer produced under otherwise identical conditions except that a chromium-oxide based catalyst used during formation thereof has been reduced with DEALE prior to being injected into the gas phase reactor system. Moreover, as demonstrated in FIG. 3, polymers characterized by having a flow index that does not vary by more than 3 times, 3.5 times, 4 times, 5 times, etc. across the particle size fractions collected on sieve screens 18, 35 and 60 from the full screen set of 10, 18, 35, 60, 120, 200 US mesh can be produced.

In comparative Examples 10 and 11, Catalyst D (DEALE reduced silica supported chromium oxide) was used to obtain a polymer having a flow index value of 5.9 at about 98° C. and 10.6 at 104° C. under the reaction conditions in Table 1.

Examples 12, 13 and 14 employ the same catalyst D with DEALE added to the reactor at different amounts. It can be seen that higher polymer flow indices were obtained without raising reactor temperature. Under a constant set of reactor conditions it can be seen that the polymer flow index increased as the DEALE concentration was increased.

These results show that DEALE fed in situ to the reactor can increase polymer flow index with both reduced and unreduced silica supported chromium oxide catalysts without the need to increase oxygen levels or reaction temperatures. It can also be seen that under a fixed set of conditions, polymer flow index can be controlled by varying the concentration or feed ratio of DEALE to the reactor.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the invention, additionally, they do not exclude impurities and variances normally associated with the elements and materials used.

Only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All documents cited herein are fully incorporated by reference for all jurisdictions in which such incorporation is permitted and to the extent such disclosure is consistent with the description of the present invention. While the invention has been described with respect to a number of embodiments and examples, those skilled in the art, having benefit of this disclosure, will appreciate that other embodiments can be devised which do not depart from the scope and spirit of the invention as disclosed herein.

What is claimed is:

1. A method for producing a polymer, comprising:
injecting a chromium oxide-based catalyst into a gas phase reactor system;
contacting a gaseous monomer with the catalyst in the reactor system for polymerizing the monomer to form a polymer; and
adding an alkyl aluminum alkoxide in situ to the reactor system in an effective amount for reducing a molecular weight of the polymer to about a target molecular weight.

2. A method for producing a polyolefin, comprising:
determining an initial set of operating conditions for producing a polyolefin in a fluidized bed reactor system including a temperature, a hydrogen concentration, an oxygen concentration and optionally a comonomer concentration;
selecting a chromium oxide-based catalyst that has been reduced with diethylaluminum ethoxide (DEALE) based on a desired property of the polyolefin and the operating temperature;
contacting a monomer with the catalyst in the fluidized bed reactor system;
cooling a recycle stream of the fluidized bed reactor system for maintaining about the initial operating temperature;
adding DEALE in situ to the reactor system in an effective amount for reducing a molecular weight of the polymer to about a target molecular weight;
measuring a flow index or melt index of the polymer; and
adjusting at least one condition from the initial set of operating conditions based on the measured flow index or melt index.

3. The method according to claim 1 or 2, wherein the catalyst is a chromium oxide on dehydrated silica.

4. The method according to any one of claims 1-3, wherein the catalyst is a titanated chromium oxide on dehydrated silica.

5. The method according to any one of claims 1 to 4, wherein about 1 ppb to about 500 ppb by volume oxygen is affirmatively added to the reactor system.

6. The method according to claim 1, wherein the alkyl aluminum alkoxide is fed to the reactor system at a rate equivalent to less than about 60 parts per million by weight of the alkyl aluminum alkoxide relative to a rate of the monomer added to the reactor system.

7. The method according to claim 1 or 6, further comprising setting a reaction temperature based on a target molecular weight distribution of the polymer.

8. The method according to any of claim 1 or 6-7, further comprising measuring a flow index or melt index of the polymer, the flow or melt index being indicative of a molecular weight of the polymer; and adjusting a feed rate of the alkyl aluminum alkoxide added in situ based on the measured flow or melt index.

9. The method according to claim 8, wherein an alkyl aluminum alkoxide/Cr molar ratio of materials in the reactor system is kept about constant.

10. The method according to any of claim 1 or 6-9, wherein the chromium-oxide based catalyst has been reduced with an alkyl aluminum alkoxide prior to being injected into the gas phase reactor system.

11. The method according to any of claim 1 or 6-10, wherein the chromium-oxide based catalyst does not include an alkyl aluminum alkoxide, wherein a flow index of the polymer vs. particle size of the polymer varies less than a flow index vs. particle size of a polymer produced under otherwise identical conditions except that a chromium-oxide based catalyst used during formation thereof has been reduced with an alkyl aluminum alkoxide prior to being injected into the gas phase reactor system.

12. The method according to any of claim 1 or 6-11, wherein the alkyl aluminum alkoxide is diethylaluminum ethoxide (DEALE).

13. The method according to any of claims 1 to 12, further comprising contacting a gaseous comonomer with the catalyst in the reactor system.

14. The method according to claim 2, further comprising adjusting a feed rate of the DEALE added in situ while increasing or decreasing the polymerization temperature.

15. The polymer produced by the method of any one of claims 1-14, wherein the polymer product is characterized as having a flow index that does not vary by more than 3.5 times across the particle size fractions collected on sieve screens 18, 35 and 60 from a full screen set of 10, 18, 35, 60, 120, 200 US mesh.

16. A polymerization reactor system, comprising:
a reactor vessel;
a mechanism for operatively adding a chromium oxide-based catalyst to the reactor vessel;
a mechanism for operatively adding a monomer to the reactor vessel, the monomer contacting the catalyst in the reactor vessel and forming a polymer; and
a mechanism for operatively adding an alkyl aluminum alkoxide in situ to the reactor vessel in an effective amount for reducing a molecular weight of the polymer to about a target molecular weight.

17. The system according to claim 16, wherein the reactor system is a gas phase polymerization reactor system.

18. The system according to claim 16, wherein the reactor system is a liquid phase polymerization reactor system.

19. A polymer product, comprising:
a polyolefin product of a chromium-based catalyst polymerization reaction, the polyolefin product characterized by having a flow index that does not vary by more than about 3.5 times across the particle size fractions collected on sieve screens 18, 35 and 60 from a full screen set of 10, 18, 35, 60, 120, 200 US mesh.
